(19) United States
(12) Patent Application Publication
(10) Pub. No.: US 2022/0219078 A1
(43) Pub. Date: Jul. 14, 2022

(54) SYSTEMS AND METHODS FOR A CONNECTED ARCADE CABINET WITH CLOUD GAMING AND BROAD-CASTING CAPABILITIES

(71) Applicant: Ping-Kang Hsiung, El Segundo, CA (US)

(72) Inventor: Ping-Kang Hsiung, El Segundo, CA (US)

(73) Assignee: Ping-Kang Hsiung, El Segundo, CA (US)

(21) Appl. No.: 17/615,785

(22) PCT Filed: Jun. 1, 2020
(86) PCT No.: PCT/US2020/035611

§ 371 Date: Dec. 1, 2021

Related U.S. Application Data
(60) Provisional application No. 62/855,938, filed on Jun. 1, 2019.
(60) Provisional application No. 62/894,963, filed on Sep. 2, 2019.

(51) Int. Cl. A63F 13/335; A63F 13/90

(52) U.S. Cl. CPC A63F 13/335; A63F 13/90

(57) ABSTRACT

Embodiments of the present disclosure provide for systems and methods for a connected arcade cabinet with cloud gaining and broadcasting capabilities. In operation, an arcade cabinet may receive user input indicative of user credentials for accessing the cloud gaming server. Responsive to receiving user input indicative of connecting to a cloud gaming server, the arcade cabinet may connect to the cloud gaming server. Responsive to receiving user input indicative of selecting a game instance of a game installed on the cloud gaming server, the arcade cabinet may receive a transmission of an encoded game play video of the game instance of the game installed on the cloud gaming server, from the cloud gaming server. The arcade cabinet may locally decode and display the encoded game play video of the game instance of the game installed on the cloud gaming server, at the arcade cabinet.

### CROSS-REFERENCE TO RELATED APPLICATIONS

This application claims priority to provisional application No. 62/855,938, filed on Jun. 1, 2019, titled “Arcade Cabinet Connected with Cloud Gaming and Broadcasting” as well as provisional application No. 62/894,963 filed on Sep. 2, 2019, titled “Arcade Cabinet Connected with Cloud Gaming and Broadcasting,” both of which are hereby incorporated by reference in their entirety.

### TECHNICAL FIELD

Embodiments of the invention relate generally to a connected arcade system with cloud gaming and broadcasting capabilities. Examples of connecting an arcade cabinet to a cloud gaming server for playing an encoded game play video of a game instance of a game installed on a cloud gaming server, as well as connecting an arcade cabinet to a broadcast streaming service to stream a game instance of a game, are described.

### BACKGROUND

Video gaming is a popular form of entertainment for children and adults alike. For decades, the ability to play video games was limited to commercially operated places of business, such as amusement arcades, shopping centers, and other amusement facilities, which housed various types of video gaming machines called arcade cabinets. Examples of such arcade cabinets included upright cabinets, table cabinets, candy cabinets, deluxe cabinets, cockpit cabinets, and the like. While arcade cabinets provided considerable entertainment value, they have traditionally been limited, by their capacity to support only locally stored games, their lack of portability, and the complexity associated with upgrading their hardware components to support more resource intensive games.

Over the last few decades, the video gaming landscape has changed considerably, with the introduction of mobile, PC, and game console devices. These new video gaming devices were made possible at least in part because of the rapid development of processing technology, including better color ranges, more sprites, and the introduction of graphical technologies such as scaling and vector graphics. As a result, the development of powerful laptop and desktop computers, along with capable headsets, mice, controllers, and monitors have made personal PC gaming possible. Similarly, the development of high-powered smartphones and tablets, with optimized mobile operating systems, large touchscreen displays, impressive cameras, and capable hardware components (e.g., CPUs, GPUs, RAM, storage, batteries, etc.) has made the mobile gaming experience possible. These new technologies provided similar entertainment value to that of their predecessors, but unlike traditional arcade cabinets, mobile, PC, and game console devices remedied some of the shortfalls of traditional arcade cabinets. For example mobile, PC, and game console devices generally enjoy ease of portability and the ability to support purchased games that do not require local storage. As a result, the rise in popularity of mobile, PC, and game console devices, was accompanied by commensurate decline in popularity of arcade cabinet-based video gaming.

In more recent years, with utilization of elastic resources and widely deployed datacenters came the advent of cloud computing, and consequently, cloud video gaming, which even further changed the video gaming landscape. Cloud video gaming enables the offloading of various complex tasks that would normally take place on mobile, PCs, or game console devices, such as high-definition 3D rendering. Cloud video gaming became even more important as the resources needed to render increasingly complex games on traditional mobile, PC, and game console devices became more expensive to purchase, and even harder to implement as a hardware upgrades. As a result of cloud video gaming, a resource-intensive game may be rendered in the cloud, streamed over a network, and decoded and displayed for local execution and play, regardless of the resource capacity of mobile, PC, or game console devices.

Unlike mobile, PC, and game console devices, however, other gaming devices such as arcade cabinets, have been technically incapable of utilizing cloud video gaming capabilities. For example, arcade cabinet hardware typically does not have internet connectivity and is a closed system that has only game installed on the local storage of the dedicated hardware and has no or limited expandability of storage or CPU or GPU beyond physically allowed within the cabinet. Without the networking or proper hardware and operating system capabilities, it is technically (e.g., compute resources) impossible for the arcade cabinet to run modern (e.g., compute resource intensive) mobile, PC, and game console device games. Additionally, broadcasting to a streaming service requires complex setup and configuration from the user to broadcast at a suitable quality, and has also been technically impossible to accomplish.

### SUMMARY

Embodiments described herein relate to systems and methods for a connected arcade cabinet with cloud gaming and broadcasting capabilities. In operation, an arcade cabinet may receive user input indicative of user credentials for accessing a cloud gaming server. In some examples, the received user credentials may include user identification information data, user name data, email data, password data, payment information data, any other information suitable for accessing a cloud gaming server, or combinations thereof.

Using the user credentials and responsive to receiving user input indicative of connecting to the cloud gaming server, the arcade cabinet may connect to the cloud gaming server. In some examples, the arcade cabinet may connect to the cloud gaming server based on calling an API corresponding to the cloud gaming server to initiate connection.

Responsive to receiving user input indicative of selecting a game instance of a game installed on the cloud gaming server, the arcade cabinet may receive a transmission of an encoded game play video of the game instance of the game installed on the cloud gaming server, from the cloud gaming server.

Based on receiving the transmission of the encoded game play video of the game instance of the game installed on the cloud gaming server, the arcade cabinet may locally decode and display the encoded game play video of the game instance of the game installed on the cloud gaming server. In some examples, locally decoding and displaying the encoded game play video of the game instance of the game installed on the cloud gaming server, at the arcade cabinet, may be further based on calling, by the arcade cabinet, an API corresponding to the cloud gaming server to initiate streaming of the encoded game play video from the cloud gaming server to the arcade cabinet, for decoding and display at the arcade cabinet.

Using a broadcast streaming service, the arcade cabinet may broadcast a game instance of a game to others (e.g., to friends on a friends list). In some examples, the arcade cabinet may broadcast (in near real time) an encoded game play video of a cloud game (e.g., a game installed on the cloud gaming server). In other examples, the arcade cabinet may broadcast (in near real time) a local game (e.g., a game stored locally on the arcade cabinet). In other examples, the arcade cabinet may record a game instance of a game (e.g., either a cloud game or a local game) for later broadcasting.

### BRIEF DESCRIPTION OF THE DRAWINGS

Reference is now made to the following descriptions taken in conjunction with the accompanying drawing, in which:

FIG. 1 is a schematic illustration of a connected arcade system, arranged in accordance with examples described herein;

FIG. 2 is a schematic illustration of one example of a user interface of an arcade cabinet of a connected arcade system, arranged in accordance with examples described herein; and

FIG. 3 illustrates a flow chart of a method for playing an encoded game play video of a game instance of a game installed on a cloud gaming server from an arcade cabinet, arranged in accordance with examples described herein.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Arcade cabinets have been a source of entertainment for decades. While arcade cabinets have provided considerable entertainment value, they have traditionally been limited by their capacity to support only locally stored games, their lack of portability, and the complexity associated with upgrading their hardware components to support more resource intensive games. While the introduction of mobile, PC, and game consoles devices remedied some of the drawbacks of the traditional arcade cabinet, they too had their own set of drawbacks. As gaming technology advanced, and the compute resources required to support newer games increased, these drawbacks became even clearer. Cloud video gaming has enabled the offloading of various complex tasks that would normally take place on mobile, PCs, and game console devices. Unfortunately, arcade cabinets have been technically incapable of taking advantage of cloud video gaming. Accordingly, it may improve a user's video gaming experience to be able to connect an arcade cabinet to a cloud gaming server to play games other than those locally stored on the arcade cabinet. It may further improve the user's video gaming experience to be able to broadcast the user's gameplay of an instance of a game on an arcade cabinet to others by connecting the arcade cabinet to a broadcast streaming service.

Examples described herein are generally directed towards systems and methods for a connected arcade cabinet with cloud gaming and broadcasting capabilities. In this regard, embodiments described herein enable improvements in arcade cabinet video gaming technology by enabling the connection of an arcade cabinet to a cloud gaming server to play games not locally stored (e.g., remotely stored games, games stored in the cloud gaming server) on the arcade cabinet, and that the arcade cabinet may not be able to play otherwise due to the resource-heavy nature of supporting such gameplay or due to incompatible settings of the hardware or operating system. Further, embodiments described herein enable improvements in arcade cabinet video gaming technology by enabling the connection of an arcade cabinet to a broadcast streaming service to broadcast an encoded game play video of a game instance of a game from the arcade cabinet to, for example other individuals (e.g., friends on a friends list, friends on a Skype friend's list, etc.).

In some examples, an arcade cabinet may receive user input indicative of user credentials for accessing the cloud gaming server. In some examples, the received user credentials may include user identification information data, user name data, email data, password data, payment information data, any other information suitable for accessing a cloud gaming server, or combinations thereof.

In some examples, based on (or using) the received user credentials, and responsive to receiving user input indicative of connection to the cloud gaming server, the arcade cabinet may connect to the cloud gaming server. In some examples, the arcade cabinet may connect to the cloud gaming server via a network (e.g., a data network) that may facilitate communication between the arcade cabinet and the cloud gaming server. In some examples, the arcade cabinet may connect to the cloud gaming server based on calling an API corresponding to the cloud gaming server to initiate a connection.

In some examples, responsive to receiving user input indicative of selecting a game instance of a game installed on the cloud gaming server, the arcade cabinet may receive a transmission of an encoded game play video of the game instance of the game installed on the cloud gaming server, via the network, from the cloud gaming server.

In some examples, based on receiving the transmission of the encoded game play video of the game instance of the game installed on the cloud gaming server, the arcade cabinet may locally decode and display the encoded game play video of the game instance of the game installed on the cloud gaming server, at the arcade cabinet. In some examples, locally decoding and displaying the encoded game play video of the game instance of the game installed on the cloud gaming server, at the arcade cabinet, may be further based on calling, by the arcade cabinet, an API corresponding to the cloud gaming server to initiate streaming from the cloud gaming server to the arcade cabinet.

In some examples, locally decoding and displaying the encoded game play video of the game instance of the game installed on the cloud gaming server may be further based on the arcade cabinet decoding the transmission stream from the could gaming server. In some examples, the transmission stream of the encoded game play video of the game instance of the game installed on the cloud gaming server from the cloud gaming server to the arcade cabinet may be formatted using various video compression technologies (or codec formats). For example, some of the codec formats include H.264, H.265, VP8, VP9, or any other suitable codec format, or combinations thereof, at a suitable quality, such as, for example, 720P at 60 FPS, 1080P at 30 FPS, and/or 1080P at 60 FPS, or other suitable graphics quality.

In some examples, responsive to receiving user input indicative of broadcasting the encoded game play video of the game instance of the game installed on the cloud gaming server, the arcade cabinet may broadcast the encoded game play video of the game instance of the game installed on the cloud gaming server, via the network, using the broadcast streaming service.

In some examples, using the broadcast streaming service, the arcade cabinet may broadcast the encoded game play video of the game instance of the game installed on the cloud gaming server to other individuals, such as, for example, a friends list. In some examples, to broadcast the encoded game play video of the game instance of the game installed on the cloud gaming server, the arcade cabinet may encode or make to encode the video component of the game instance of the game into a video compression format, such as, for example, H.264 video compression format (however, other suitable compression formats may be used), at a suitable quality, such as, for example, 720P at 60 FPS, 1080P at 30 FPS, and/or 1080P at 60 FPS, or other suitable graphics qualities.

As should be understood, the arcade cabinet may utilize the broadcast streaming service to stream the encoded game play video of the game instance of the game installed on the cloud gaming server to even further individuals, such as, for example, users of other connected arcade cabinets, users of other broadcast streaming services, users of mobile, PC, or game console devices, and the like. As should be further understood, the discussion of a friends list, as described herein, is in no way limiting to the types of individuals to which the arcade cabinet may broadcast.

In some examples, responsive to receiving a user input indicative of playing a game instance of a game locally stored on the arcade cabinet, the arcade cabinet may locally execute and provide encoded local game play of the game instance of the game locally stored on the arcade cabinet, at the arcade cabinet. In some examples, and responsive to receiving user input indicative of broadcasting the encoded game play video of the game instance of the game locally stored on the arcade cabinet, the arcade cabinet may broadcast the encoded game play video of the game instance of the game locally stored on the arcade cabinet, via the network, using the broadcast streaming service.

As should be understood, the arcade cabinet may utilize the broadcast streaming service to stream the encoded game play video of the game instance of the game locally stored on the arcade cabinet to even further individuals, such as, for example, users of other connected arcade cabinets, users of other broadcast streaming services, users of mobile, PC, or game console devices, and the like. As should be further understood, the discussion of a friends list, as described herein, is in no way limiting to the types of individuals to which the arcade cabinet may broadcast.

In some examples, the encoded game play video of the game instance of the game installed on the cloud gaming server may be recorded for broadcasting, using the broadcast streaming service, at a later date. In some examples, a encoded game play video of a game instance of a game stored locally on the arcade cabinet may be recorded for broadcasting, using the broadcast streaming service, at a later date. In some examples, the recorded encoded game play video of the game instance of the game installed on the cloud gaming server may be stored on, for example, a data store. In some examples, recorded encoded game play video of the game instance of the game stored locally on the arcade cabinet may be stored on, for example, a data store.

Advantageously, the systems and methods described herein solve the ability to connect a cloud gaming server that enables the local decoding and display of an encoded game play video of the game instance of the game installed on the cloud gaming server, without the need of expensive and impractical hardware upgrades, or the need to install the game locally on the arcade cabinet. Additionally, the systems and method described herein further solve the problem of simplifying the process to broadcast encoded game play video of the game instance of the game installed on the cloud gaming server, or to broadcast encoded game play video of a game instance of a game stored locally on the arcade cabinet, from an arcade cabinet to others (e.g., other users, friends included in a friends list, etc.) by connecting to and using a broadcast streaming service.

Stated differently, advantageously, systems and methods described herein will allow a user, using an arcade cabinet described herein, to play more graphically advanced games on the arcade cabinet that the arcade cabinet cannot otherwise play and/or support on/using the local arcade cabinet hardware. Further, the user will also be able to broadcast to a streaming service (e.g., a broadcast streaming service) with a single button command. In some embodiments, the arcade cabinet may connect to the cloud gaming server and the broadcast streaming service at the same time. In some embodiments, arcade cabinet may connect exclusively to the cloud gaming server. In some embodiments, arcade cabinet may connect exclusively to the broadcast streaming service.

The systems and methods described herein remedy these problems by, for example, adding cloud gaming capabilities to an arcade cabinet. For example, and as described herein, because the arcade cabinet is now enabled to connect to a cloud gaming server, the hardware design for the arcade cabinet may be dramatically changed. More specifically, the need for a state-of-the-art PC or dedicated hardware with high-power GPU card to run the graphic- and compute-intensive games is no longer required. The design focus is shifted to having one low-power, short latency, low GPU and memory footprint, essentially a OTT streaming box motherboard optimized for swift 2D graphic display (menu navigation of titles browsing), video decoding (for playing streaming games), robust connectivity (RJ-45 and dual-band WiFi), and versatile input (Bluetooth, USB, HDMI).

Traditionally, PC or dedicated hardware used to be more than 50% of the cost budget in constructing an arcade cabinet, but for systems and methods described herein that enable a connected arcade cabinet, the CPU board is less than 10% of the total BOM cost (build-of-material).

Additionally, enabling an arcade cabinet to have cloud gaming and broadcasting capabilities eliminates (or greatly reduces) the thermal problem (e.g., over-heating, etc.) that a high-power PC or dedicated hardware cause (big power supply, big ventilation space in the arcade cabinet, noisy heat dissipating fan). Low power consumption that systems and methods described herein enable, also means longer hardware life and easier to maintain arcade cabinets. In some embodiments, arcade cabinets described herein server as a UI/UX frontend, a streaming connected kiosk.

In embodiments, the arcade cabinet can connect to a cloud gaming server (e.g., AWS, Paperspace, Azure, IBM Softlayer, etc.) to play modern and/or resource intensive games while still using weaker hardware which may be running on Linux OS. In some embodiments, the arcade cabinet will display a user interface (UI) to select locally stored (e.g., installed) games, games installed on a cloud gaming server, or combinations thereof, from a list of selectable games. In some embodiments, the UI of the arcade cabinet will additionally provide for cloud gaming options that let a user choose from a list of cloud gaming enabled games or connect to the user's own cloud gaming virtual or physical server (e.g., a cloud gaming server or a local server).

In some embodiments, the UI of the arcade cabinet will be simplified so that a user need only press a single button (e.g., Stream Now) to connect to a broadcast streaming service (e.g., TWITCH, Stadia, GeForce Now, etc.) and begin broadcasting an encoded game play video of the game instance of the game installed on the cloud gaming server or a game instance of a game locally stored on the arcade cabinet, to others via the broadcast streaming service.

In some embodiments, and for improved user experience, video quality configurations for both playing a game instance of a game installed on a cloud gaming server, as well as broadcasting the encoded game play video of the game instance of the game installed on the cloud gaming server or a game instance of a game locally stored on the arcade cabinet to others via the broadcast streaming service, may be automatically configured such that the user need not make settings modifications. In other embodiments, however, the settings may be modifiable, such that the user may manually adjust the video quality of playing a game instance of a game, broadcasting the encoded game play video of a game instance of a game, or both. In some examples, the UI of the arcade cabinet and the user experience (UX) of the arcade cabinet may be created using a Simple DirectMedia Layer 2 (SDL2) library. As should be understood, however, other suitable libraries may be used to create the arcade cabinet UI and UX.

In some embodiments, the motherboard of arcade cabinets described herein may be placed in various locations, including: (1) in the main cabinet, and the mainboard to communication with the control-deck via wired, Bluetooth, or 2.4G ad hoc connectivity. Multiple different control deck modules are replaceable and “dockable” to the arcade cabinet in this implementation; and (2) in the control-deck, and the input from the controller are directly wired to the motherboard. The advance of this approach is the control-deck with the mainboard inside can be removed from the cabinet and connect its HDMI output to a TV display directly functioning as a game console. In some examples, to allow multiple external game hosts to connect into the arcade, we implement an Arcade Play Link (APL) that takes HDMI input and synchronize the game hosts' input to the controller in our system via BT or USB.

Advantageously, by enabling an arcade cabinet with cloud gaming and broadcasting capabilities, the sources of games that are available to play on a connected arcade cabinet are no longer restricted to low-resource, arcade-native games. Instead, they now may include, but are not limited to, new games developed or ported to the arcade native execution, PC games (e.g., Windows-supported PC games, Linux-supported PC games), game console device games, past and new arcade cabinet games (though running emulators), past game console device games (through running emulators), and Android-supported games (through running emulators).

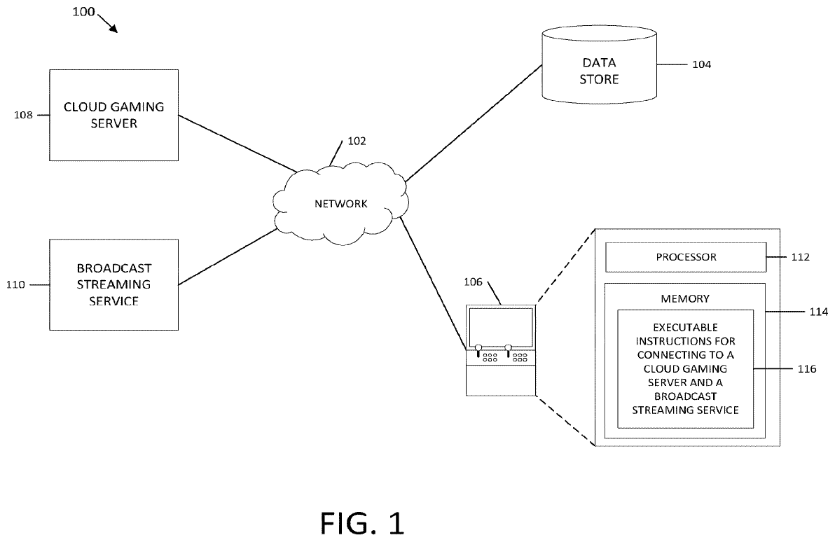

FIG. 1 is a schematic illustration of a connected arcade system 100 in accordance with examples described herein. It should be understood that this and other arrangements and elements (e.g., machines, interfaces, function, orders, and groupings of functions, etc.) can be used in addition to or instead of those shown, and some elements may be omitted altogether. Further, many of the elements described may be implemented as discrete or distributed components or in conjunction with other components, and in any suitable combination and location. Various functions described herein as being performed by one or more components may be carried out by firmware, hardware, and/or software. For instance, and as described herein, various functions may be carried out by a processor executing instructions stored in memory.

Among other components not shown, system 100 of FIG. 1 includes data store 104, arcade cabinet 106, cloud gaming server 108, and broadcast streaming service 110. Arcade cabinet 106 includes processor 112 and memory 114. Memory 114 includes (e.g., may be encoded with) executable instructions for connecting to a cloud gaming server and a broadcast streaming service 116. It should be understood that system 100 shown in FIG. 1 is an example of one suitable architecture for implementing certain aspects of the present disclosure. Additional, fewer, and/or different components may be used in other examples. It should be noted that implementations of the present disclosure are equally applicable to other types of devices such as mobile computing devices and devices accepting gesture, touch, and/or voice input. Any and all such variations, and any combination thereof, are contemplated to be within the scope of implementations of the present disclosure. Further, although illustrated as separate components of arcade cabinet 106, any number of components can be used to perform the functionality described herein. Although illustrated as being a part of arcade cabinet 106, the components can be distributed via any number of devices. For example, processor 112 can be provided via one device, sever, or cluster of servers, while memory 114 may be provided via another device, server, or cluster of servers.

Arcade cabinet 106, cloud gaming server 108, and broadcast streaming service 110 may have access (via network 102) to at least one data store or repository, such as data store 104, which may include data related to user credential data (e.g., user credentials) and any accompanying metadata. For example, data related to user credential data may include user identification information data, user name data, email data, password data, payment information data, other financial data, other contact information data, and related metadata. In some examples, data store 104 may include additional data related to various game instances of various games, and any accompanying metadata. In implementations of the present disclosure, data store 104 may be search for one or more data related to user credential data and game instance of a game data, described herein.

Such information stored in data store 104 may include a plurality of unrelated data repositories or sources within the scope of embodiments of the present technology. Data store 104 may be local to arcade cabinet 106, cloud gaming server 108, or broadcast streaming service 110. Data store 104 may be updated at any time, including an increase and/or decrease in the amount and/or types of data related to user credential data, data related to various game instances of various games, and all accompanying metadata.

Examples described herein may include computing devices, such as arcade cabinet 106 of FIG. 1. In some examples, arcade cabinet 106 may facilitate connection to a cloud gaming server, such as cloud gaming server 108, to enable locally decoding and displaying, an encoded game play video of the game instance of the game installed and running on the cloud gaming server, at the arcade cabinet. In some examples, arcade cabinet 106 may facilitate connection to a broadcast streaming service, such as broadcast streaming service 110, to enable the broadcast of the encoded game play video of the game instance of the game installed on the cloud gaming server that is being locally decoded and displayed at the arcade cabinet 106. In some examples, arcade cabinet 106 may facilitate connection to a broadcast streaming service, such as broadcast streaming service 110, to enable the broadcast of the game instance of the game locally stored on arcade cabinet 106.

Arcade cabinet 106 may include computer readable media encoded with executable instructions, and a processor that may execute the instructions to provide for connection to a cloud gaming server, such as cloud gaming server 108, and connection to a broadcast streaming service, such as broadcast streaming service 110. As described herein, and among other components not shown, arcade cabinet 106 includes processor 112 and memory 114. Memory 114 may include executable instructions for connecting to a cloud gaming server and a broadcast streaming service 116. In some examples, arcade cabinet 106 may be communicatively coupled to cloud gaming server 108 via a network, such as network 102. In some examples, arcade cabinet 106 may be communicatively coupled to a broadcast streaming service, such as broadcast streaming service 110.

Arcade cabinets, such as arcade cabinet 106 described herein may include one or more processors, such as processors, such as processor 112. Any kind and/or number of processors may be present, including one or more central processing unit(s) (CPUs), graphics processing units (GPUs), other computer processors, mobile processors, digital signal processors (DSPs), microprocessors, computer chips, and/or processing units configured to execute machine-language instructions and process data, such as executable instructions for connecting to a cloud gaming server and a broadcast streaming service 116.

Arcade cabinets, such as arcade cabinet 106 described herein, may further include memory 114. Any type or kind of memory may be present (e.g., read only memory (ROM), random access memory (RAM), solid state drive (SSD), and secure digital card (SD card). While a single box is depicted as memory 114, any number of memory devices may be present. The memory 114 may be in communication (e.g., electrically connected) to processor 112.

Memory 114 may store executable instructions for execution by processor 112, such as executable instructions for connecting to a cloud gaming server and a broadcast streaming service 116. Processor 112 being be communicatively coupled (e.g., over a network, over a data network) to cloud gaming server 108 and broadcast streaming service 110, and via the execution of executable instructions for connecting to a cloud gaming server and a broadcast streaming service 116, may connect arcade cabinet 106 to cloud gaming server 108 and broadcast streaming service 110. More particularly, and based in part on processor 112 executing executable instructions for connecting to a cloud gaming server and a broadcast streaming service 116 as descried herein, arcade cabinet 106, may receive user input indicative of user credentials for accessing the cloud gaming server. As described herein, in some examples, the received user credentials may include user identification information data, user name data, email data, password data, payment information data, any other information suitable for accessing a cloud gaming server, or combinations thereof.

Based in part on processor 112 executing executable instructions for connecting to a cloud gaming server and a broadcast streaming service 116 as descried herein, using the user credentials and responsive to receiving user input indicative of connecting to cloud gaming server 108, arcade cabinet 106 may connect to the cloud gaming server 108. As described herein, in some examples, arcade cabinet 106 may connect to cloud gaming server 108 via network 102 (e.g., a data network) that may facilitate communication between arcade cabinet 106 and cloud gaming server 108. In some examples, arcade cabinet 106 may connect to cloud gaming server 108 based on calling an API corresponding to cloud gaming server 108 to initiate connection between arcade cabinet 106 and cloud gaming server 108.

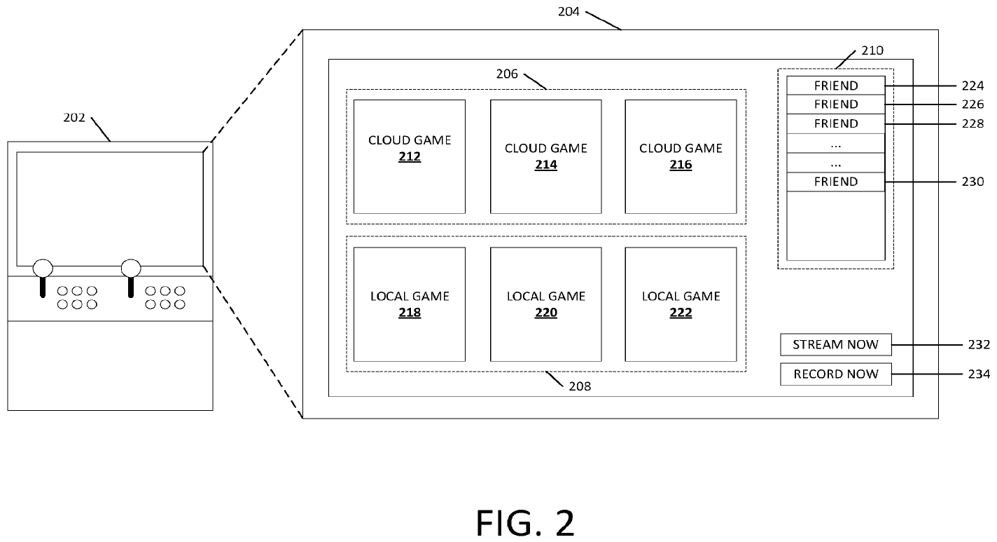

Based in part on processor 112 executing executable instructions for connecting to a cloud gaming server and a broadcast streaming service 116 as descried herein, and responsive to receiving user input indicative of selecting a game instance of a game installed on cloud gaming server 108 (such as, for example, cloud game 212 of cloud gaming list 206 of FIG. 2), arcade cabinet 106 may receive a transmission, from cloud gaming server 108 to arcade cabinet 106, via network 102, of an encoded game play video of the game instance of the game installed on cloud gaming server 108.

Based in part on processor 112 executing executable instructions for connecting to a cloud gaming server and a broadcast streaming service 116 as descried herein, and based on receiving the transmission of the encoded game play video of the game instance of the game installed on the cloud gaming server, such as cloud gaming server 108, arcade cabinet 106 may locally decode and display the encoded game play video of the game instance of the game installed on the cloud gaming server, at arcade cabinet 106. In some examples, locally decoding and displaying the encoded game play video of the game instance of the game installed on the cloud gaming server, at the arcade cabinet 106, may be further based on calling, by arcade cabinet 106, an API corresponding to cloud gaming server 108 to initiate streaming from cloud gaming server 108 to arcade cabinet 106.

In some examples, locally decoding and displaying the encoded game play video of the game instance of the game installed on the cloud gaming server may be further based on arcade cabinet 106 decoding the transmission stream from could gaming server 108. In some examples, the transmission stream of the encoded game play video of the game instance of the game installed on the cloud gaming server from cloud gaming server 108 to arcade cabinet 106 may be formatted using various video compression technologies (or codec formats), such as, for example, H.264, H.265, VP8, VP9, or any other suitable codec format, or combinations thereof, at a suitable quality, such as, for example, 720P at 60 FPS, 1080P at 30 FPS, and/or 1080P at 60 FPS, or other suitable graphics qualities.

Based in part on processor 112 executing executable instructions for connecting to a cloud gaming server and a broadcast streaming service 116 as descried herein, in some examples, responsive to receiving user input indicative of broadcasting the encoded game play video of the game instance of the game installed on the cloud gaming server, arcade cabinet 106 may broadcast or make to broadcast the encoded game play video of the game instance of the game installed on the cloud gaming server, via network 102, using broadcast streaming service 110.

In some examples, using broadcast streaming service 110, arcade cabinet 106 may broadcast or make to broadcast the encoded game play video of the game instance of the game installed on the cloud gaming server to other individuals, such as, for example, a friends list (such as friends list 210 of FIG. 2). In some examples, to broadcast the encoded game play video of the game instance of the game installed on the cloud gaming server, arcade cabinet 106 may encode or make to encode the game play video of the game instance of the game into a video compression format, such as, for example, H.264 video compression format (however, other suitable compression formats may be used), at a suitable quality, such as, for example, 720P at 60 FPS, 1080P at 30 FPS, and/or 1080P at 60 FPS, or other suitable graphics qualities.

Based in part on processor 112 executing executable instructions for connecting to a cloud gaming server and a broadcast streaming service 116 as descried herein, in some examples, responsive to receiving a user input indicative of playing a game instance of a game locally stored on the arcade cabinet, arcade cabinet 106 may locally execute and provide local game play of the game instance of the game locally stored on the arcade cabinet, at arcade cabinet 106. In some examples, and responsive to receiving user input indicative of broadcasting the encoded game play video of the game instance of the game locally stored on the arcade cabinet, arcade cabinet may 106, may broadcast the encoded game play video of the game instance of the game locally stored on the arcade cabinet, via network 102, using broadcast streaming service 110.

Examples of cloud gaming servers, such as cloud gaming server 108, described herein may include, such as, for example, any cloud gaming server that is capable of performing computationally complex tasks that support the local game play and execution of computationally expensive games installed on a cloud gaming server, on a connected arcade cabinet, such as arcade cabinet 106. While no components of cloud gaming server 108 are shown, it should be understood that in some embodiments, cloud gaming server may include a command (input/output) receiver, game logic, game instance of a game renderer, audio encoder, video encoder, video streamer, and any other components suitable for proper operation of a cloud gaming server, such as cloud gaming server 108. Examples of cloud gaming server 108 may include, but is not limited to, AWS, Paperspace, Azure, Softlayer, and the like. In some examples, games may be installed on cloud gaming server 108 via various gaming platforms, such as Steam, Origin, GOG, UPlay, Battle.net, Epic, etc. As should be appreciated, other methods for installing and storing games in a cloud gaming server, such as cloud gaming server 108, are contemplated to be within the scope of this disclosure.

Examples of broadcast streaming services, such as broadcast streaming service 110, described herein may include, such as, for example, any broadcast streaming service that is capable of broadcasting a stream of an encoded game play video of the game instance of the game installed on the cloud gaming server as well as a game instance of a game locally stored on an arcade cabinet. While no components of broadcast streaming service 110 are shown, it should be understood that in some embodiments, broadcast streaming service 110 may include any components suitable for streaming the (either live or recorded) encoded game play video of the game instance of the game installed on the cloud gaming server as well as a game instance of a game locally stored on an arcade cabinet, to others, such as, for example, friends in a friends list, or users of other connected arcade cabinets.

Now turning to FIG. 2, FIG. 2 is a schematic illustration of one example of a user interface of an arcade cabinet in a connected arcade system, arranged in accordance with examples described herein. FIG. 2 includes arcade cabinet 200, and user interface 204. User interface 204 includes cloud gaming list 206, local gaming list 208, friends list 210, stream now button 232, and record now button 234. Cloud gaming list 206 includes cloud game 212, cloud game 214, and cloud game 216. Local gaming list 208 includes local game 218, local game 220, and local game 222. Friends list 210 includes friend 224, friend 226, friend 228, and friend 230.

As described herein, arcade cabinet 202 may connect to a cloud gaming server, such as cloud gaming server 108 of FIG. 1. In some examples, and as described herein, arcade cabinet 202 may enable the local decoding and display of an encoded game play video of the game instance of the game installed on the cloud gaming server as well as a game instance of a game locally stored on an arcade cabinet, such as cloud gaming server 108 of FIG. 1. As one example, responsive to receiving a user input at arcade cabinet 202 indicative of selecting cloud game 212 from cloud game list 206, arcade cabinet 202 may receive a transmission of an encoded game play video of a game instance of cloud game 212 installed on cloud game server 108 of FIG. 1, via network 102 of FIG. 1. Arcade cabinet 202 may enable the local decoding and display of the encoded game play video of the game instance of cloud game 212 installed on the cloud gaming server, at arcade cabinet 202.

In some examples, and as described herein, arcade cabinet 202 may enable the local execution and game play of a game instance of a game locally stored on arcade cabinet 202. As one example, responsive to receiving a user input at arcade cabinet 202 indicative of selecting local game 218 from local game list 208, arcade cabinet 202 may enable the local execution and game play of a game instance of local game 218 stored locally on the arcade cabinet, at arcade cabinet 202.

As described herein, arcade cabinet 202 may, responsive to receiving user input indicative of broadcasting an encoded game play video of the game instance of the game installed on the cloud gaming server, broadcast the encoded game play video of the game instance of the game installed on the cloud gaming server, via the network, using a broadcast streaming service, such as broadcast streaming service 110 of FIG. 1. As further described herein, arcade cabinet 202 may, responsive to receiving user input indicative of broadcasting the encoded game play video of a game instance of a game stored locally on arcade cabinet 202, broadcast the encoded game play video of the game instance of the game stored locally on arcade cabinet 202, via the network, using a broadcast streaming service, such as broadcast streaming service 110 of FIG. 1.

As one example, responsive to receiving a user input (e.g., a user selecting the stream now button 232), arcade cabinet 202 may broadcast the encoded game play video of the game instance of cloud game 212, via network 102, using broadcast streaming service 110. As another example, responsive to receiving a user input (e.g., user selecting stream now button 232), arcade cabinet 202 may broadcast the encoded game play video of a game instance of local game 218, via network 102, using broadcast streaming service 110. In either example, using broadcast streaming service 110, arcade cabinet 202 may broadcast cloud game 212 and/or local game 218 to other individuals, such as, for example, friend 224, friend 226, friend 228, and/or friend 230 of friends list 210.

In some examples, responsive to receiving user input indicative of recording an encoded game play video of the game instance of the game installed on the cloud gaming server e (e.g., a user selecting the record now button 234), such as the encoded game play video of the game instance of cloud game 212 or the game instance of local game 218, arcade cabinet 202 may record the encoded game play video of the game instance of cloud game 212 or the game instance of local game 218 for later broadcasting using, such as, for example, broadcast streaming service 110 of FIG. 1.

While user interface 204 is illustrated in FIG. 2, it should be appreciated that other user interface configurations and layouts are contemplated as being within the scope of this disclosure. For example, in some examples, user interface 204 may only include a cloud game list. In other examples, user interface 204 may only include a local game list. In further examples, user interface 204 may include or may not include a friends list. In even further examples, user interface 204 may or may not include a stream now button or a record now button.

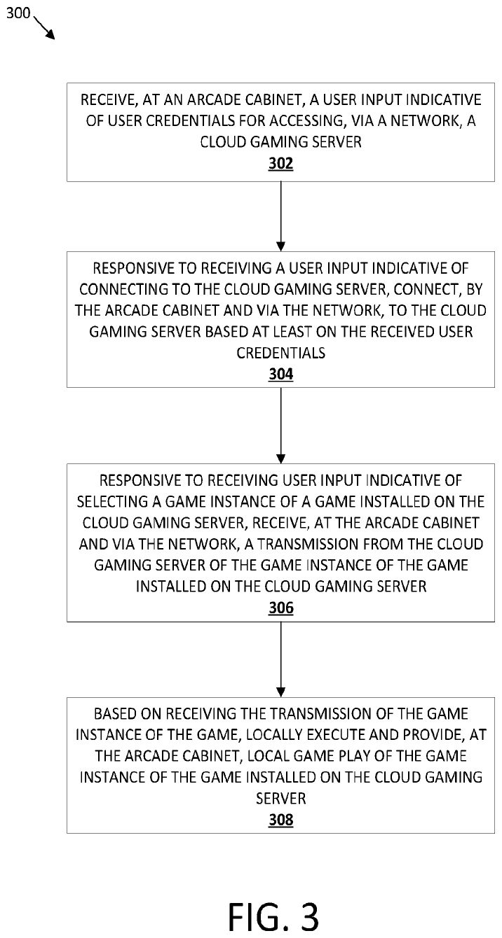

Turning now to FIG. 3, FIG. 3 is a flowchart of a method 300 arranged in accordance with examples described herein. The method 300 may be implemented, for example, using connected arcade system 100 of FIG. 1.

The method 300 includes receiving, at an arcade cabinet, a user input indicative of user credentials for accessing, via a network, a cloud gaming server at block 302, responsive to receiving a user input indicative of connecting to the cloud gaming server, connecting, by the arcade cabinet and via the network, to the cloud gaming server based at least on the received user credentials at block 304, responsive to receiving user input indicative of selecting a game instance of a game installed on the cloud gaming server, receiving, at the arcade cabinet and via the network, a transmission from the cloud gaming server of an encoded game play video of the game instance of the game installed on the cloud gaming server at block 306, and based on receiving the transmission of the encoded game play video of the game instance of the game, locally decoding and displaying, at the arcade cabinet, the encoded game play video of the game instance of the game installed on the cloud gaming server at block 308.

Block 302 recites receiving, at an arcade cabinet, a user input indicative of user credentials for accessing, via a network, a cloud gaming server. As described herein, in some examples, the received user credentials may include user identification information data, user name data, email data, password data, payment information data, any other information suitable for accessing a cloud gaming server, or combinations thereof.

Block 304 recites responsive to receiving a user input indicative of connecting to the cloud gaming server, connecting, by the arcade cabinet and via the network, to the cloud gaming server based at least on the received user credentials. As described herein, in some examples, the arcade cabinet may connect to the cloud gaming server via a network (e.g., a data network) that may facilitate communication between the arcade cabinet and the cloud gaming server. In some examples, the arcade cabinet may connect to the cloud gaming server based on calling an API corresponding to the cloud gaming server to initiate connection.

Block 306 recites responsive to receiving user input indicative of selecting a game instance of a game installed on the cloud gaming server, receiving, at the arcade cabinet and via the network, a transmission from the cloud gaming server of an encoded game play video of the game instance of the game installed on the cloud gaming server.

Block 308 recites and based on receiving the transmission of the encoded game play video of the game instance of the game, locally decoding and displaying, at the arcade cabinet, the encoded game play video of the game instance of the game installed on the cloud gaming server. As described herein, in some examples, locally decoding and displaying the encoded game play video of the game instance of the game installed on the cloud gaming server, at the arcade cabinet, may be further based on calling, by the arcade cabinet, an API corresponding to the cloud gaming server to initiate streaming from the cloud gaming server to the arcade cabinet.

In some examples, locally decoding and displaying the encoded game play video of the game instance of the game installed on the cloud gaming server may be further based on the arcade cabinet decoding the transmission stream from the could gaming server. In some examples, the transmission stream of the encoded game play video of the game instance of the game installed on the cloud gaming server from the cloud gaming server to the arcade cabinet may be formatted using various video compression technologies (or codec formats), such as, for example, H.264, H.265, VP8, VP9, or any other suitable codec format, or combinations thereof, at a suitable quality, such as, for example, 720P at 60 FPS, 1080P at 30 FPS, and/or 1080P at 60 FPS, or other suitable graphics qualities.

From the foregoing it will be appreciated that, although specific embodiments of the invention may have been described herein for purposes of illustration, various modification may be made without deviating from the scope of the invention.

The particulars shown herein are by way of example and for purposes of illustrative discussion of the preferred embodiments of the present invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a while and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

While various drawbacks of existing systems and possible advantages of examples described herein are discussed herein, it is to be understood that these drawbacks and possible advantages are provided to facilitate appreciation of the described examples only. Not all examples of the described technology may address all, or any, of the described drawbacks. Similarly, not all examples of the described technology may have all, or nay, of the described advantages.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A gaming system comprising:
a data network configured to facilitate communication between an arcade cabinet, a cloud gaming server, a broadcast streaming service, or combinations thereof;
the arcade cabinet configured to receive user input indicative of user credentials for accessing the cloud gaming server;
the arcade cabinet further configured to, using the user credentials and responsive to receiving user input indicative of connecting to the cloud gaming server, connect to the cloud gaming server;
the arcade cabinet further configured to, responsive to receiving user input indicative of selecting a game instance of a game installed on the cloud gaming server, receiving a transmission, from the cloud gaming server to the arcade cabinet, via the network, an encoded game play video of the game instance of the game installed on the cloud gaming server; and
the arcade cabinet further configured to, based on receiving the transmission of the encoded game play video of the game instance of the game installed on the cloud gaming server, locally decode and display the encoded game play video of the game instance of the game installed on the cloud gaming server, at the arcade cabinet.

2. The system of claim 1, wherein the arcade cabinet is further configured to:
responsive to receiving user input indicative of broadcasting the encoded game play video of the game instance of the game installed on the cloud gaming server, broadcasting the encoded game play video of the game instance of the game installed on the cloud gaming server, via the network, using the broadcast streaming service.

3. The system of claim 1, wherein the arcade cabinet is further configured to:
responsive to receiving user input indicative of broadcasting an encoded game play video of a game instance of a game locally stored on the arcade cabinet, broadcasting the encoded game play video of the game instance of the game locally stored on the arcade cabinet, via the network, using the broadcast streaming service.

4. The system of claim 1, wherein the user credentials comprise user identification information data, user name data, email data, password data, payment information data, or combinations thereof.

5. The system of claim 1, wherein connecting to the cloud gaming server is further based on calling, by the arcade cabinet, an API corresponding to the cloud gaming server to initiate connection.

6. The system of claim 1, wherein locally decoding and displaying the encoded game play video of the game instance of the game installed on the cloud gaming server is further based on calling, by the arcade cabinet, an API corresponding to the cloud gaming server to initiate streaming.

7. The system of claim 2, wherein broadcasting the encoded game play video of the game instance of the game installed on the cloud gaming server further comprises broadcasting the encoded game play video of the game instance of the game installed on the cloud gaming server to users included in a friends list.

8. A method comprising:
receiving, at an arcade cabinet, a user input indicative of user credentials for accessing, via a network, a cloud gaming server;
responsive to receiving a user input indicative of connecting to the cloud gaming server, connecting, by the arcade cabinet and via the network, to the cloud gaming server based at least on the received user credentials;
responsive to receiving user input indicative of selecting a game instance of a game installed on the cloud gaming server, receiving, at the arcade cabinet and via the network, a transmission from the cloud gaming server of an encoded game play video of the game instance of the game installed on the cloud gaming server; and
based on receiving the transmission of the encoded game play video of the game instance of the game installed on the cloud gaming server, locally decoding and displaying, at the arcade cabinet, the encoded game play video of the game instance of the game installed on the cloud gaming server.

9. The method of claim 8, further comprising:
responsive to receiving a user input indicative of broadcasting the encoded game play video of the game instance of the game installed on the cloud gaming server, broadcasting, via the network, the encoded game play video of the game instance of the game installed on the cloud gaming server, using a broadcast streaming service.

10. The method of claim 8, further comprising:
responsive to receiving a user input indicative of broadcasting an encoded game play video of a game instance of a game locally stored on the arcade cabinet, encoding and broadcasting, at the arcade cabinet and via the network, the encoded game play video of the game instance of the game locally stored on the arcade cabinet, using a broadcast streaming service.

11. The method of claim 8, wherein connecting to the cloud gaming server is further based on calling, by the arcade cabinet, an API corresponding to the cloud gaming server to initiate connection.

12. The method of claim 8, wherein locally decoding and displaying the encoded game play video of the game instance of the game installed on the cloud gaming server is further based on calling, by the arcade cabinet, an API corresponding to the cloud gaming server to initiate streaming.

13. A non-transitory computer readable medium having computer-executable instructions stored thereon that, if executed by one or more processors of an arcade cabinet, cause the arcade cabinet to perform one or more steps comprising:
receiving user input indicative of user credentials for accessing a cloud gaming server;
using the user credentials and responsive to receiving user input indicative of connecting to the cloud gaming server, connect to the cloud gaming server;
responsive to receiving user input indicative of selecting a game instance of a game installed on the cloud gaming server, receiving a transmission, from the cloud gaming server to the arcade cabinet, via a network, of an encoded game play video of the game instance of the game installed on the cloud gaming server; and
based on receiving the transmission of the encoded game play video of the game instance of the game installed on the cloud gaming server, locally decoding and displaying the encoded game play video of the game instance of the game installed on the cloud gaming server, at the arcade cabinet.

14. The computer readable media of claim 13, further comprising:
responsive to receiving user input indicative of broadcasting the encoded game play video of the game instance of the game installed on the cloud gaming server, broadcasting the encoded game play video of the game instance of the game installed on the cloud gaming server, via the network, using a broadcast streaming service.

15. The computer readable media of claim 13, further comprising:
responsive to receiving user input indicative of broadcasting an encoded game play video of a game instance of a game locally stored on the arcade cabinet, encoding and broadcasting the encoded game play video of the game instance of the game locally stored on the arcade cabinet, via the network, using a broadcast streaming service.

16. The computer readable media of claim 13, wherein connecting to the cloud gaming server is further based on calling, by the arcade cabinet, an API corresponding to the cloud gaming server to initiate connection.

17. The computer readable media of claim 13, wherein locally decoding and displaying the encoded game play video of the game instance of the game installed on the cloud gaming server is further based on calling, by the arcade cabinet, an API corresponding to the cloud gaming server to initiate streaming.
